(19) United States
(12) Patent Application Publication
(10) Pub. No.: US 2004/0052528 A1
(43) Pub. Date: Mar. 18, 2004

(54) Jitter control in optical network

(76) Inventors: Ross Halgren, Collaroy Plateau (AU); Brian Robert Brown, Collaroy (AU); Balasupramaniam Prabakrishnan, Westmead (AU)

Correspondence Address: CHRISTIE, PARKER & HALE, LLP, 350 WEST COLORADO BOULEVARD, SUITE 500, PASADENA, CA, 91105, US

(21) Appl. No.: 10/145,590

(22) Filed: May 13, 2002

(51) Int. Cl. H04J 14/02; H04B 10/00

(52) U.S. Cl. 398/75; 398/47; 398/176; 398/155

(57) ABSTRACT

An electro-optic interface structure for use in a multi-protocol OEO WDM network, the interface structure comprising a rate multiplying encoding unit for applying a rate multiplying line code to an electrical transmit data signal prior to conversion of the electrical transmit data signal into an optical WDM channel signal, and a rate dividing decoding unit for applying a corresponding rate dividing line code to an electrical receive data signal converted from a received optical WDM channel signal, wherein the encoding unit is arranged such that, in use, the same rate multiplying line code can be applied to electrical transmit data signals of different protocols, and wherein the decoding unit is arranged such that, in use, the application of the same corresponding rate dividing line code can create electrical signals of different protocols.

### FIELD OF THE INVENTION

The present invention relates broadly to jitter control in optical networks, in particular in optical wavelength division multiplex (WDM) networks.

### BACKGROUND OF THE INVENTION

All-optical WDM telecommunication networks (whether dense WDM or coarse WDM) have the attribute that native signals of virtually any format, protocol or data rate can be sent over different wavelengths. In principle, client interfaces to WDM channels can be optimised for a single format, protocol and data rate. However, such an approach would lead to the design of a large number of client electro-optic interfaces to WDM networks, to cater for the above mentioned range of bit-rates and protocols. To achieve a high flexibility, a large number of spare holdings would be required and physical exchanges would have to take place where bit-rates and/or protocols are to be changed for a particular client interface.

Accordingly, there is a need to design client electro-optic interfaces to WDM networks that can support a range of bit-rates and protocols to minimise spare holdings and to enable rapid provisioning of new client services.

In addition to the above need for multi-protocol, multi-rate client interfaces, optical electrical optical (OEO) cross-connect switches, OEO add/drop multiplexers (OEO-ADMs) and OEO repeaters, with 2R or 3R signal regeneration may be employed in the optical transport network (2R includes amplification and reshaping, while 3R additionally includes retiming functions). The OEO switches, OEO-ADMs and repeaters should cater for the entire range of protocols and data rates to be supported. This is a difficult design task due to the wide dynamic range required for optical receiver, electronic switching, transmission line and transmitter bandwidth and clock regenerator frequencies. In particular, meeting the jitter specifications for all supported protocols and rates is particularly challenging.

There are several sources of phase jitter added to signals passing through AC coupled transmission stages in an OEO WDM network. These are outlined below.

Random jitter is generally caused by thermal noise in all-optical amplifiers and PIN/APD receiver amplifiers (so-called 1R regeneration stages). Shot noise—which dominates in APD receivers, is another source of random jitter.

Noise (in contrast to dispersion) is first added as a signal amplitude variation which, due to the finite (non-zero) rise/fall time of binary signals translates to phase noise (jitter) as the signal crosses each binary detection threshold in so-called 2R regeneration stages.

Noisy power supply lines can also cause amplitude modulation of input signals at all stages in the transmission chain. Since power supply noise has low frequency content, this results in low frequency jitter—which is also called “wander”.

In an OEO node or client interface, differential electrical transmission is often used to minimise jitter accumulation due to pulse width distortion, electrical interference and crosstalk. AC coupling is further utilized to improve transmission over differential transmission lines connecting dissimilar logic families and across backplanes (where common-mode voltage differences can cause problems). With differential transmission, 2R regeneration at the end of each transmission stage is simplified, since there is no need for a binary detection threshold input. Elimination of the binary threshold level and associated voltage offset errors that can occur, results in reduced pulse width distortion and associated random jitter.

Whilst AC coupling can reduce pulse width distortion and associated random jitter, AC coupling in all stages of an OEO node or client interface can also add pattern-dependant or “systematic” jitter if the High Pass Filter (HPF) response is not matched to the data protocol being passed.

Pattern-dependent jitter is most evident when a long sequence of Consecutive Identical Digits (CID) is followed by a short data pattern (eg, 1010), or visa versa. Such scenarios cause the AC-coupling capacitors in the transmission path to charge-up to a voltage ΔV which is then subtracted from the signal amplitude Ai at the input to the following binary detector of a 2R regeneration stage.

This so called “low frequency droop” has the effect of causing a shift in the binary detector threshold—which is known as “baseline wander”. Due to the finite (non zero) rise/fall times of the data transitions, the effect of low frequency droop is to cause the signal to cross the binary detection threshold earlier (or later as the case may be) by an amount ΔT. In the presence of noise (thermal or other), the signal can drop below the binary detection hysteresis threshold or rise above it as the case may be, resulting in erroneous output phase transitions and associated errors. Between such extremes is a state of increasing pattern dependent jitter and error rate build up.

Both random and pattern dependent jitter accumulate as a signal passes through each stage in an OEO transmission system. In the absence of incorporated retiming stages, (so called 3R regenerator stages), which are inherently jitter-reducing stages, random jitter an the one hand, due to receiver thermal noise for example, accumulates as the square root of the number of receivers connected in series in a transmission system. Significantly, pattern-dependent jitter an the other hand, due to AC-coupling stages for example, accumulates linearly with the number of such stages connected in series.

In summary, for each transmission stage in switched multi-protocol OEO WDM network, one can define a Band Pass Filter (BPF) response, which is common to all transmission channels in that network. The BPF response is defined by the maximum network bit-rate (which sets the Low Pass Filter roll-off frequency LPF-f_{-3 dB}) and the maximum achievable value of CR_{T} (which sets the High Pass Filter roll-off frequency HPF-f_{-3 dB}) where C is the AC-coupling capacitance and R_{T} is the transmission line load resistance. The value of HPF-f_{-3 dB} in turn places a practical limit on the maximum CID duration supportable.

The combination of maximum bit-rate and maximum CID duration places an upper and lower bound on the range of standard (and proprietary) protocols that can be transported (without additional encoding) through the transmission channels in an OEO WDM network.

Throughout this specification, the term OEO WDM network will be used to refer to networks which incorporate AC-coupling in OEO switches and/or OEO-ADMs, and/or OEO repeaters, in contrast to all-optical networks with optical switching and optical amplification. All-optical networks with optical switching and optical amplification inherently avoid the need to meet jitter specifications of the relevant electronic components.

In at least a preferred embodiment, the present invention provides a simple design for supporting and meeting the transmission requirements and associated jitter specifications of a wide range of different protocols and data rates on the same client electro-optic interface to a WDM multiplexer, and for supporting a wider range of protocols and data rates on intervening OEO repeaters, OEO cross connect switches and OEO add/drop multiplexers in an OEO WDM network.

### SUMMARY OF THE INVENTION

In accordance with a first aspect of the present invention there is provided an electro-optic interface structure for use in a multi-protocol OEO WDM network, the interface structure comprising a rate multiplying encoding unit for applying a rate multiplying line code to an electrical transmit data signal prior to conversion of the electrical transmit data signal into an optical WDM channel signal, and a rate dividing decoding unit for applying a corresponding rate dividing line code to an electrical receive data signal converted from a received optical WDM channel signal, wherein the encoding unit is arranged such that, in use, the same rate multiplying line code can be applied to electrical transmit data signals of different protocols, and wherein the decoding unit is arranged such that, in use, the application of the same corresponding rate dividing line code can create electrical signals of different protocols.

In one embodiment the encoding unit comprises a plurality of encoding elements and the decoding unit comprises a plurality of decoding elements, wherein different pairs of encoding and decoding elements apply, in use, different line codes, and the encoding unit further comprises an encoder select element for selecting one of the encoding elements, and a decoding select element for selecting one of the decoding elements.

Preferably, the interface structure further comprises an encoding by-pass element for by-passing one or more associated encoding elements for an electrical transmit data signal having a suitable format and a rate above a threshold value, and a decoding by-pass element for by-passing one or more decoding elements for an electrical receive data signal corresponding to an electrical transmit data signal having a suitable format and a rate above the threshold value. The encoder select element and the decoder select element may comprise the encoding by-pass element and the decoding by-pass element respectively.

The interface structure may comprise at least one encoding sampling element arranged, in use, to oversample the electrical transmit data signal prior to the application of the rate multiplying line code, whereby a total rate multiplying factor greater than a factor inherent to said applied rate multiplying line code is achieved.

The interface structure may comprise at least one decoding sampling element arranged, in use, to de-sample the decoded electrical receive data signal.

In one embodiment, the encoding unit is arranged, in use, such that the encoded electrical transmit data signal is synchronised with respect to the original electrical transmit data signal.

In another embodiment, the encoding unit is arranged, in use, such that the encoded electrical transmit data signal is asynchronous with respect to the original electrical transmit data signal, wherein a total rate multiplying factor in the interface structure for said original electrical transmit data signal is chosen sufficiently high such that a sampling jitter in the encoded electrical transmit data signal is below a predetermined threshold value.

The encoding unit in one embodiment comprises a first clock data recovery (CDR) element arranged, in use, to be set selectively to the rate of the electrical transmit data signal for retiming the electrical transmit data signal.

The encoding unit may further comprise a first clock multiplier element arranged, in use, to create a multiplied clock output signal based on a clock output signal of the first CDR element for use in one of the encoding elements. The encoding unit may further comprise a first clock divider element arranged, in use, to create a divided clock output signal based on the clock output signal of the first CDR element for use in said one of the encoding elements. Accordingly, fractional rate multiplying line codes can be applied in such an embodiment for spectrally efficient encoding, e.g. 10/8 encoding options.

The first clock multiplier element may comprise a second CDR element.

The decoding structure in one embodiment comprises a third CDR element arranged, in use, to be set selectively to the rate of the electrical receive data signal for retiming the electrical receive data signal.

The decoding unit may further comprise a second clock divider element arranged, in use, to create a divided clock output signal based on the clock output signal of the third CDR element in for use in one of the decoding elements. The decoding unit may further comprise a second clock multiplier element arranged, in use, to create a multiplied clock output signal based on a clock output signal of the third CDR element for use in said one of the decoding elements. Accordingly, fractional rate dividing line codes can be applied in such an embodiment, e.g. 8/10 decoding options.

The second clock multiplier element may comprise a fourth CDR element.

The CDR elements may comprise multi-rate CDR elements, wherein the rate multiplying codes are chosen such that, in use, the multi-rate CDR elements are capable of locking to the range of multiplied rates.

The CDR elements may comprise continuous rate CDR elements, whereby the CDR elements are capable of locking to substantially any multiplied rate, including fractionally multiplied rates.

The interface structure in a preferred embodiment enables a higher-speed out-of-band management unit to be used which utilises a portion of a low frequency spectrum not used for user data transmission in the OEO WDM network, due to the application of the rate multiplying line code, for out-of-band management data.

The interface structure may further comprise an in-band management unit arranged, in use, to utilise a portion of the multiplied rate spectrum transmitted in the OEO WDM network, due to the application of the rate multiplying line code, for an in-band management application. The in-band management application may comprise forward error control (FEC), bit-error rate estimation, signal path tracing or an end-end management application.

The interface structure may be formed on a single interface card, or in the form of an individual transmit interface card comprising the encoding unit, and an individual receive interface card comprising the decoding unit.

The encoding unit may be formed on a single card, or in the form of individual cards each comprising one or more of the encoding elements.

The decoding unit may be formed on a single card, or in the form of individual cards each comprising one or more of the decoding elements.

In a preferred embodiment, the encoding unit comprises at least one encoding element arrangement, in use, to apply a bi-phase multiplying line code, and the decoding unit comprises at least one decoding element arranged, in use, to apply a bi-phase dividing line code.

In accordance with a second aspect of the present invention there is provided a method of transmitting a user electrical transmit data signal through a multi-protocol OEO WDM network, the method comprising the steps of applying, at a source network node, a rate multiplying line code to the electrical transmit data signal prior to conversion of the electrical data signal into an optical WDM channel signal, and applying, at a destination network node, a rate dividing line code to an electrical receive data signal converted from the optical WDM channel signal, wherein the same rate multiplying line code is applied to electrical signals of different protocols at the source network node, and wherein the application of the same rate dividing line code can create electrical signals of different protocols at the destination network node.

In accordance with a third aspect of the present invention, there is provided an OEO WDM network comprising an electro-optic user interface of the first aspect of the present invention.

### BRIEF DESCRIPTION OF THE DRAWINGS

Preferred embodiments of the present invention will now be described, by way of example only, with reference to the accompanying drawings.

FIG. 1 shows a regenerative WDM Point-Point Network with OEO Repeater Nodes, embodying the present invention;

FIG. 2 shows a regenerative WDM Add/Drop Repeater Nodes with Optional OEO Switching, embodying the present invention;

FIG. 3 shows a bi-Phase Family of Line Codes with 50% Average Value, embodying the present invention;

FIG. 4 shows a standard N=2× and N=12× Synchronous Bi-Phase-Mark Encoded OC1, embodying the present invention;

FIG. 5 shows an asynchronous Bi-Phase Mark Encoding (Burst Mode Application);

FIG. 6 shows a PON Application—155 Mbit/s Burst Mode Upstream Data, embodying the present invention;

FIG. 7 shows an asynchronous Bi-Phase Mark Encoding (Burst Mode Application), embodying the present invention;

FIG. 8 shows All Client Protocols Encoded to Increase HPF-f_{-3 dB} to 25 MHz, embodying the present invention;

FIG. 9 shows a Dual Encoder Client Interface, embodying the present invention;

FIG. 10 shows a Clock Generator Schematic of the Dual Encoder Client Interface of FIG. 9 (Representative), embodying the present invention;

FIG. 11 shows a table of mode and rate control settings for the Dual Encoder Client Interface of FIGS. 9 and 10.

### DETAILED DESCRIPTION OF THE EMBODIMENTS

A preferred embodiment of the invention is the application of a single type of rate multiplying line code, at the ingress and egress (eg, client interface) to a regenerative OEO WDM network for all wavelength channels required to transport low rate, less constrained and unconstrained protocols that would otherwise limit the performance of the WDM network. Such performance limitations might include excessive jitter accumulation, transmission distance or a fundamental inability to transport a particular client data stream (such as a burst-mode packet protocol).

Another preferred embodiment is the application of a Type 1 rate multiplying line code for most protocols and a Type 2 rate multiplying line code to cover specific protocols that cannot be Type 1 encoded (eg, due to maximum channel bandwidth reasons).

For both embodiments, the invention permits the encoders to be bypassed for protocols that are already suitably encoded (considered a Type 3—null line code).

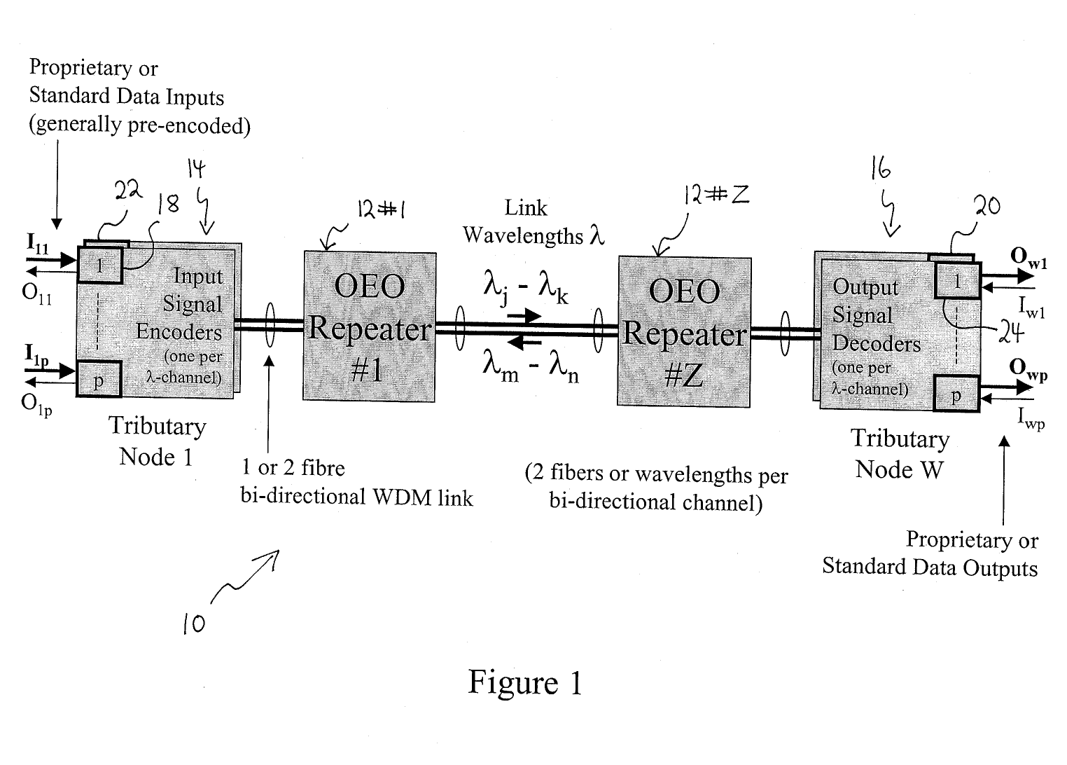

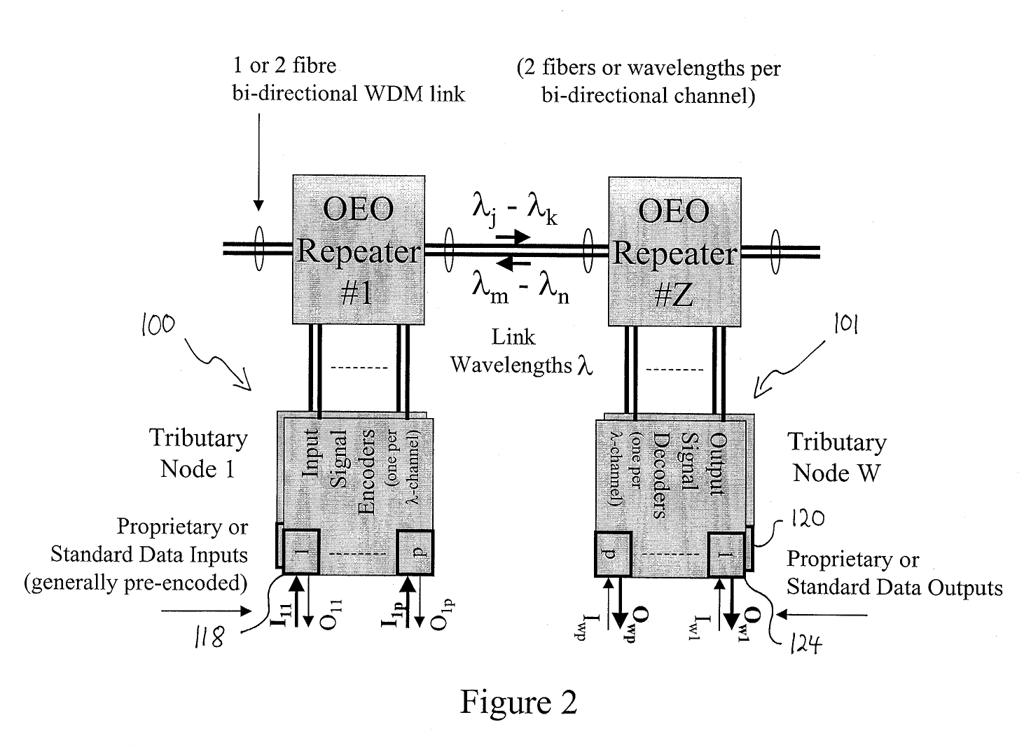

FIG. 1 and FIG. 2 illustrate a point-point repeated OEO WDM network and a WDM OEO add/drop nodes 100, 101 in such a network respectively. As detailed below, rate multiplying encoders and decoders are installed on each client interface to the WDM network.

FIG. 1 illustrates the point-point OEO WDM transmission system 10 with terminal WDM multiplexers 14, 16 at each end and OEO 12#1-12#Z repeaters along the path. Each terminal multiplexer 14, 16 comprises multiple client interfaces and associated input signal encoders e.g. 18, 20 and output signal decoders e.g. 22, 24—one each per wavelength channel (labelled 1−p).

Each encoder e.g. 18, 20 can optionally encode the client data stream (eg, I₁₁) using a rate multiplying code such as bi-phase, or it can be programmed to bypass the native client protocol without additional encoding. The latter encoder-bypass option is used if the client data rate is too high such that additional encoding would exceed the maximum WDM channel data rate fₘₐₓ of the network 10. The encoder-bypass option is also used if the native client protocol has already been suitably encoded (eg, 8B/10B) such that it matches the bandpass filter characteristics of the network 10.

At the other end of the transmission link, the associated client egress interface would decode the stream received from the WDM network e.g. at decoder 24, or it would bypass the decoder (if not encoded by the ingress interface) to transparently pass the native data stream to the client output port O_{wl}.

FIG. 2 illustrates an extension of the point-point network 10 example shown in FIG. 1 to include WDM add/drop multiplexing and optional OEO switching functions at nodes 100, 101. In this case the ingress and egress client interfaces to a wavelength connection may be located at either the terminal multiplexers (not shown, compare FIG. 1) or the add-drop multiplexer nodes 100, 101. In the case of ring network configurations, there may be only add/drop multiplexers, and no terminal multiplexers. Apart from this topological difference, the encoding and decoding functions on the client interfaces are the same as in FIG. 1.

That is, each encoder, e.g. 118, 120 can optionally encode a client data stream (e.g. I₁₁) using a rate multiplying code such as bi-phase, or it can be programmed to by-pass the native client protocol without additional encoding. At the other end of the transmission link, e.g. at node 101, the associated client egress interface decodes the stream received from the WDM network e.g. at decoder 124, or it by-passes the decoder (if not encoded by the ingress interface) to transparently pass the native datastream to the client output port O_{w1}.

In the following, details of rate multiplying line codes suitable for implementing the present invention in various embodiments will be described.

For the purpose of preferred embodiments of this invention, rate multiplying line codes are selected which meet the minimum requirements of zero DC and reduced low frequency spectral content in the encoded data, and supportability by continuous-rate CDRs of the rate multiplied clock frequency for all protocols and data rates up to the maximum WDM channel rate fₘₐₓ. Preferred rate multiplying line codes include:

Synchronous Rate Doubling (N=2)—such as bi-phase line coding

Synchronous effective N=2^{M}—times Rate Doubling—such as (2×, 4×, 8× . . . oversampling)×bi-phase

Asynchronous Rate Doubling—such as bi-phase at maximum rate (fₘₐₓ)

Synchronous Fractional Rate Multiplying (eg, N=10/8)—such as 8B/10B

Asynchronous Fractional Rate Multiplying—such as 8B/10B at max. rate

A benefit of applying a single type of rate multiplying line code to most client protocols is that fewer types of client interfaces to WDM channels are required. The invention can be implemented using e.g. Small Form factor Pluggable (SFP) tributary interface optical fibre transceivers fitted to a client interface card or module. Such an universal client interface embodying the present invention thus includes the option to encode the incoming client data with the rate multiplying line code, or to bypass the encoder and forward the native protocol format to the WDM network.

The SFP type transceivers are preferable in this example to cater for the disparity that exists between the transmit/receive optical power levels and loss of signal detection and alarm thresholds associated with different optical interface protocols. Examples include: SONET OC1, OC3, OC12, OC48, OC192, SDH STM1, STM4, STM16, STM64, ATM-PON (A-PON), Ethernet PON (E-PON), 100BaseFX, Gigabit Ethernet, 10 Gigabit Ethernet, ESCON, Fibre Channel, and 2 Gbit/s Fibre Channel for example. However, it is noted that the present invention can still be implemented for other transceivers, i.e. allowing disparity in the transmit/receive optical power levels. In such an embodiment, attenuators may be used to permit inter-operability with other client equipment that does not meet a given power level specification.

It is noted that rate doubling line codes such as bi-phase may be regarded as having the premise that the excess bandwidth requirement increases the associated receiver noise—which reduces the un-repeated transmission distance. However, it has been found by the applicant that for a regenerative multi-protocol OEO WDM network, this premise is a fallacy for all WDM channel rates less than or equal to the maximum channel rate fₘₐₓ divided by the rate multiplier N. In fact, it has been found that highly unconstrained protocols and/or low data rates can just as easily degrade the transmission distance for a given BER due to low frequency droop in each of the numerous AC-coupled transmission stages that exist in a regenerative OEO network.

Clearly, a wider range of lower rate protocols can be encoded if N is as small as possible. In accordance with the rate multiplying encoder options encompassed by this invention, N=10/8 is preferably the lowest multiplier value. As such, all protocols with native data rates<fₘₐₓ/N=0.8 fₘₐₓ can be encoded by the client interface. For fₘₐₓ=2.67 Gbit/s, this means that all protocols and data rates up to 2.13 Gbit/s (such as 1.485 Gbit/s HDTV) can be 8B/10B encoded by the client interface. Since Fibre Channel, Gigabit Ethernet and 2 Gbit/s Fibre Channel are already 8B/10B encoded, then the encoder is bypassed for these particular protocols in an example embodiment, even though in theory, they fall within the 2.13 Gbit/s encoder limit.

On the other hand, N=10/8 rate multiplying encoders are not the preferred embodiment for multi-rate CDR implementations. N=2 is the lowest multiplier value for such implementations. In this case, all protocols with native data rates<fₘₐₓ/N=0.5 fₘₐₓ can be encoded by the client interface. For fₘₐₓ=2.67 Gbit/s, this means that all protocols and data rates up to 1.33 Gbit/s (including Fibre Channel and Gigabit Ethernet) can be bi-phase encoded by the client interface. Protocols with data rates>1.33 Gbit/s, such as HDTV, OC48, digitally wrapped OC48 and FEC encoded OC48 bypass the rate doubling encoder in such an embodiment.

If one assumes that a regenerative OEO WDM network has been designed to transport all data protocols in their native format with a data rate between the maximum rate and the maximum rate divided by N, then all other protocols with a rate less than or equal to the maximum data rate divided by N can be encoded with a rate multiplying code without reducing the high frequency performance of the WDM network. In fact, rate-multiplying codes such as bi-phase coding will minimize droop and associated pattern dependent jitter in AC-coupled 2R regenerator stages, thus improving their low frequency performance. For small regenerative WDM networks with few intermediate nodes, this may limit the need for 3R regeneration to the ingress and egress nodes only. Networks so designed (or parts thereof) enable the transmission of highly unconstrained and low rate synchronous protocols (both standard and proprietary) through a multi-channel, 2R regenerative OEO WDM network.

For larger WDM networks with many repeater nodes, 3R regeneration will typically be required. In such networks, rate-multiplying encoders embodying the present invention will also minimize the pattern dependent jitter in the CDR (PLL loop filter) stages of the 3R repeater nodes. This in turn will permit a larger number of 3R nodes before a more complex, elastic buffer is required to de-jitter the signal (remove low frequency wander).

In an embodiment of a regenerative OEO WDM network with multi-rate CDRs at the ingress, egress and optionally, at intermediate OEO repeater and cross connect switching nodes, each of the multi-rate CDRs is programmable and specified to operate at the highest data rate and over a wide range of standard protocols. Due to the clock multiplier/divider designs used to implement multi-rate CDRs, they are typically also specified to operate at clock rates C=2^{L} (L integer≧1) times the standard rates (up to the maximum rate). Oversampling plus rate multiplying line codes such as bi-phase are used in preferred embodiments to utilise this CDR capability.

It is noted that in contrast to the effective N=2^{M}×rate multiplying encoder options such as oversampling plus bi-phase, the 10/8 fractional rate multiplying encoders (such as 8B/10B) may not be supported by multi-rate CDRs for all the protocols that require additional encoding. Thus, continuous-rate CDRs are preferably used in such embodiments.

In the following, further details in relation to different rate multiplying line codes for use in various embodiments of the present invention will be described.

Rate Doubling Line Codes

Preferred rate doubling line codes (N=2) such as bi-phase line codes will have an equal number of binary 1s and 0s when averaged over a short period of time and will have a significant number of transitions in the symbols transmitted by the encoder so that CDRs can acquire lock and reduce input jitter and selfjitter.

An example of a preferred rate multiplying line code with N=2 but which is not bi-phase is provided here for illustrative purposes. However, there are many other rate doubling line codes possible for use in embodiments of the present invention.

The example non bi-phase line code with N=2 comprises a 16-bit frame as shown below:

E C₁C₂C₃C₄C₅C₆C₇C₈C₉C₁₀ O U where:

E is a frame sync pattern and is its inverse;

O is an in-band management data bit and is its inverse;

U is a frame parity bit and is its inverse;

C₁ C₂ . . . C₁₀ is a 10-bit code word, which may for example, be an 8B/10B encoded form of each block of 8-bits in the native data stream.

Since 8 native data bits are encoded into a 16-bit frame, this is an example of a rate-doubling line code which can be transported through a network of multi-rate CDRs. Note that it is irrelevant that the native data stream may already be 8B/10B encoded. In such cases, it will need to be 8B/10B encoded again, to generate bits C₁ to C₁₀.

The use of 8B/10B encoding to generate bits C₁-C₁₀, padded out with extra frame bits E, O, U and their inverse, guarantees that there is an equal density of 1s and 0s when averaged over a relatively short interval and that the encoded stream is highly constrained in terms of the maximum CID value, and that the encoded data rate is twice the native data rate.

The extra bandwidth redundancy is used in this case to add in-band management data and simple parity error checking. Other variants of such a rate doubling line code and frame structure could include Forward Error Correction (FEC).

It is noted that in the above example embodiment combines 8B/10B and extra bits to pad-out a frame to create a rate doubling code. For use with multi-rate CDRs, the extra pad-bits are required in the example embodiment to generate a suitable rate doubling code. However, with continuous CDRs, only the 8B/10B encoding could be utilised in a different embodiment of the present invention.

Bi-Phase Line Codes

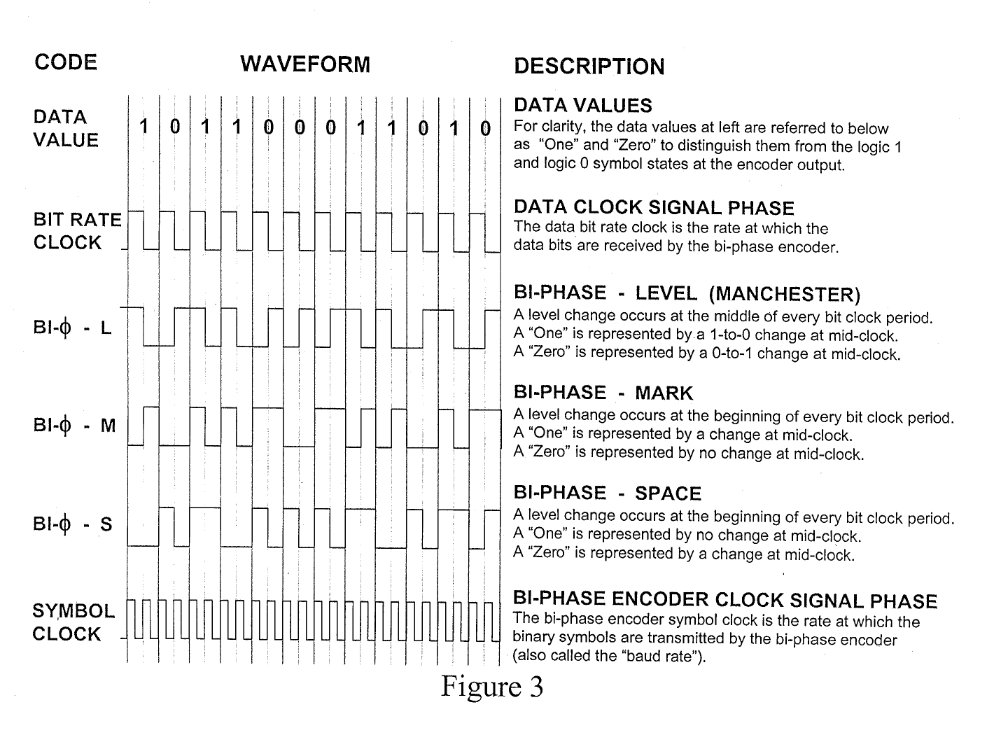

Examples of the Bi-Phase family of line codes are illustrated in FIG. 3.

As shown and described in FIG. 3, the main forms of bi-phase encoding suitable for the present invention are:

Bi-Phase Level or Manchester

Bi-Phase Mark; and

Bi-Phase Space

The bi-phase level or “Manchester” coding option, has the advantages that a clock can simply be recovered from the received data stream without the need for a CDR. However, such a clock recovery mechanism may not be robust to jitter and errors and thus is less suitable for a regenerative OEO WDM network. Additionally, the Manchester encoder is most suited to packet data streams with 1010 . . . preamble patterns (as for Ethernet) and for all input data patterns doesn't start-up as smoothly as the bi-phase mark and bi-phase space encoder variants. The preferred selection between bi-phase mark and bi-phase space depends on the applications to be supported.

If only synchronous applications are to be supported, where the native client protocol has been pre-encoded (eg, SONET OC1), then there is no preference as to which encoding format is used (bi-phase mark or bi-phase space).

For synchronous applications where there is a significant disparity between the average number of binary 1s and 0s in the native client protocol (eg, RZ), then the preference is the same as the asynchronous applications discussed below.

If asynchronous applications are to be supported such that the ingress data stream has an idle state, and if this idle state happens to be a binary 1 state, then bi-phase mark is preferred. This is because the encoded data stream for the idle state will be a repetitive 1010 . . . pattern which has a Consecutive Identical Digits, CID=1 and thus minimizes jitter accumulation and CDR lock acquisition time. In contrast, a binary 0 idle state would exhibit a repetitive 11001100 . . . pattern when bi-phase mark encoded, which will tend to cause slightly greater low frequency droop and associated jitter. The CDR lock acquisition time will also be slightly longer. Thus, if the idle state happens to be a binary 0 state, then bi-phase space is preferred. This is because the encoded data stream for the idle state will also be a repetitive 1010 . . . pattern which has a CID=1 and thus minimizes jitter accumulation and CDR lock acquisition time.

For applications that don't require in-band management or Forward Error Correction (FEC) functionality, the preferred embodiment is the bi-phase family of line codes. These are used to enable improved low frequency performance over an extended range of data rates and protocols. For continuous transmission of the client data, this is achieved by selecting the bi-phase encoded clock rate to be either N=2 times the input data rate (“standard bi-phase”) or effective N=2^{M} times the input data rate (“oversampled bi-phase” with M an integer>1). A large rate multiplier to e.g. reach the maximum WDM channel data rate is preferably used for low data rate or intermitted transmission of the client data. In this case, a sampling jitter results since the encoder clock is typically not synchronised with the client data stream. The larger the ratio between encoding rate and client data rate, the smaller the sampling jitter that results.

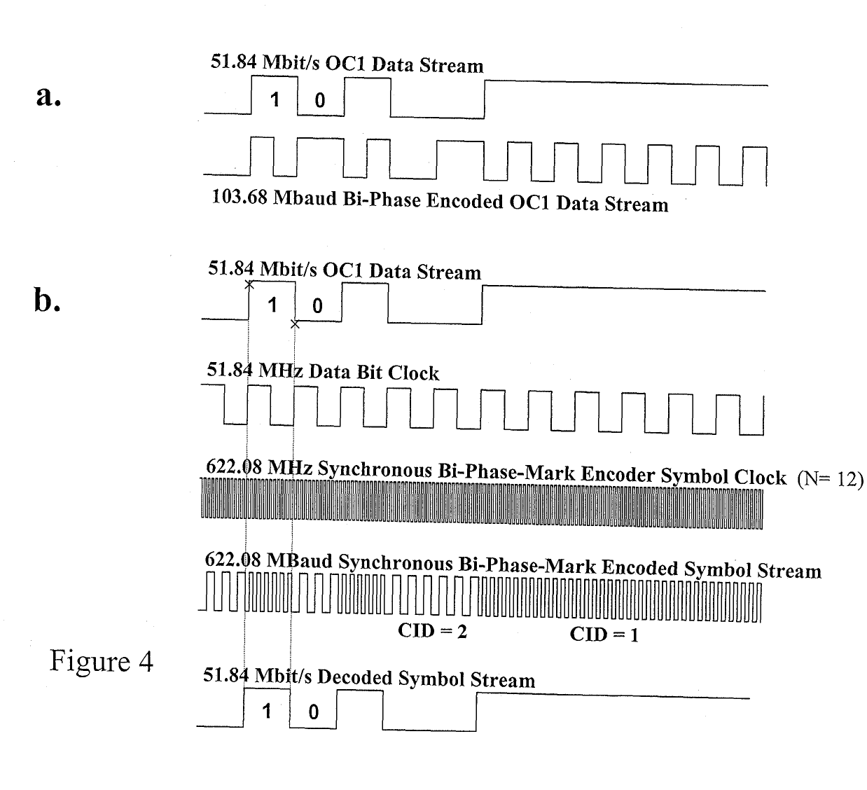

If the CDR does not support a particular synchronous bi-phase rate, eg, 103.68 MHz as required for bi-phase encoded OC1 (as shown in FIG. 4a), then the oversampled synchronous mode of operation described above may permit a bi-phase encoder clock rate to be used that is supported by the multi-rate CDRs. In such embodiments, if a specified CDR rate exists that supports an integer multiplier, then the bi-phase encoder clock can still be synchronised to the input data stream, thus avoiding the sampling jitter incurred when the bi-phase encoder clock is not synchronised to the input data stream. In this oversampled synchronous mode, the effective clock rate multiplier does not need to be large since there is no sampling jitter. For example, illustrated in FIG. 4b, effective N=12 equates to 622.08 MHz which is the OC12 rate—which will be supported by most multi-rate CDRs). The client data is first oversampled and then the oversampled client data is bi-phase encoded. Thus, effective rate multiplying with N>2 can be achieved while maintaining to utilise bi-phase line coding. Effective clock rate multipliers as high as 10-20 are more suited to handling protocols having very low data rates; highly unconstrained protocols; non-standard (proprietary) protocols; burst-mode packet protocols; and burst mode Time Division Multiple Access (TDMA) protocols.

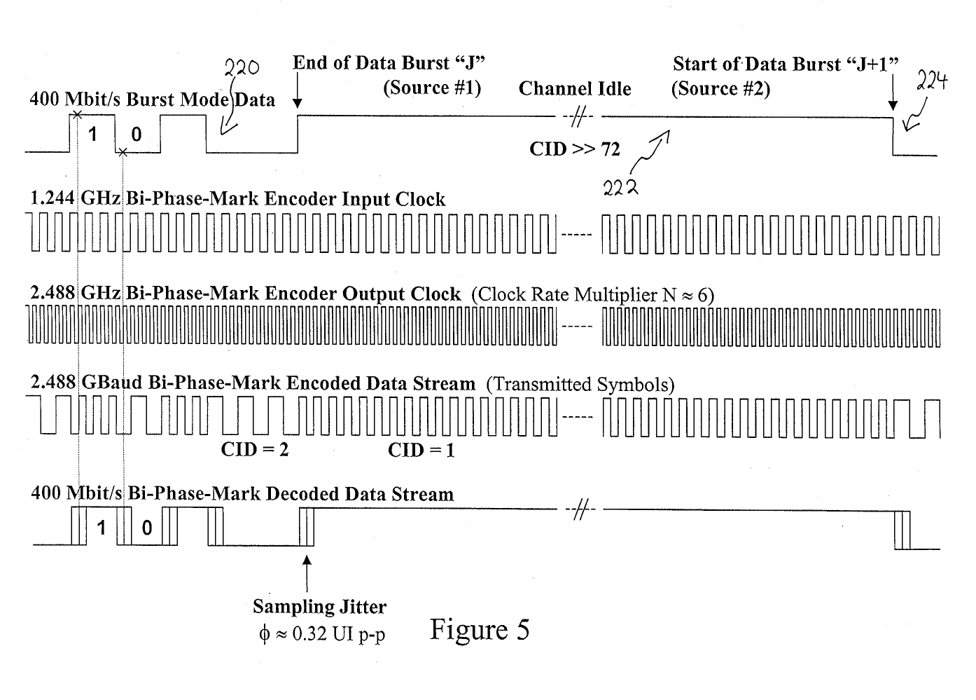

Turning now to FIG. 5, in the asynchronous mode of operation (compare burst mode 602 followed by idle period 604, which inturn is followed by a new data burst 606 in the transmit data stream 600), the bi-phase encoder input and output clock rates 607, 608 need not be synchronised in frequency or phase to the ingress data stream as long as an effective clock rate multiplier with respect to the Burst Mode Data stream 602 is sufficiently large. As illustrated in FIG. 5, the result of not synchronising the encoder clock 608 to the input data stream is a sampling jitter 610 in the encoded data stream 612. This jitter has been exaggerated in FIG. 5 by using a lower effective clock rate multiplier (N≈6). However, the jitter can be as small as 0.10 Unit Intervals (UI) for an N=20 times effective clock rate multiplier.

Since 0.20 UI of jitter is typically acceptable, then the minimum effective clock rate multiplier would be N=10 times the native data rate at 400 Mbit/s.

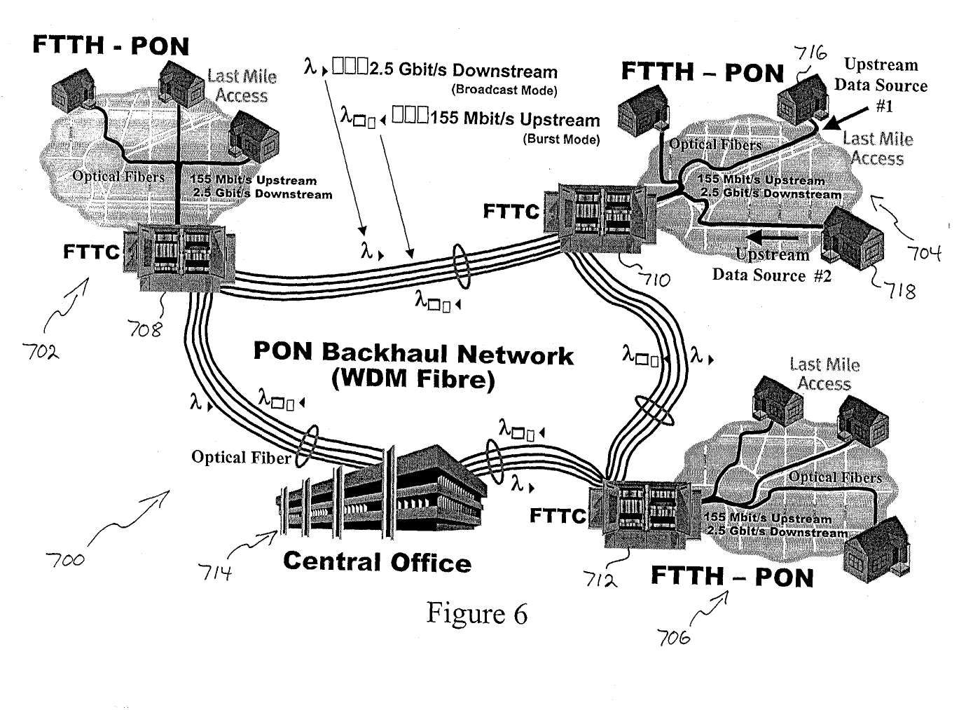

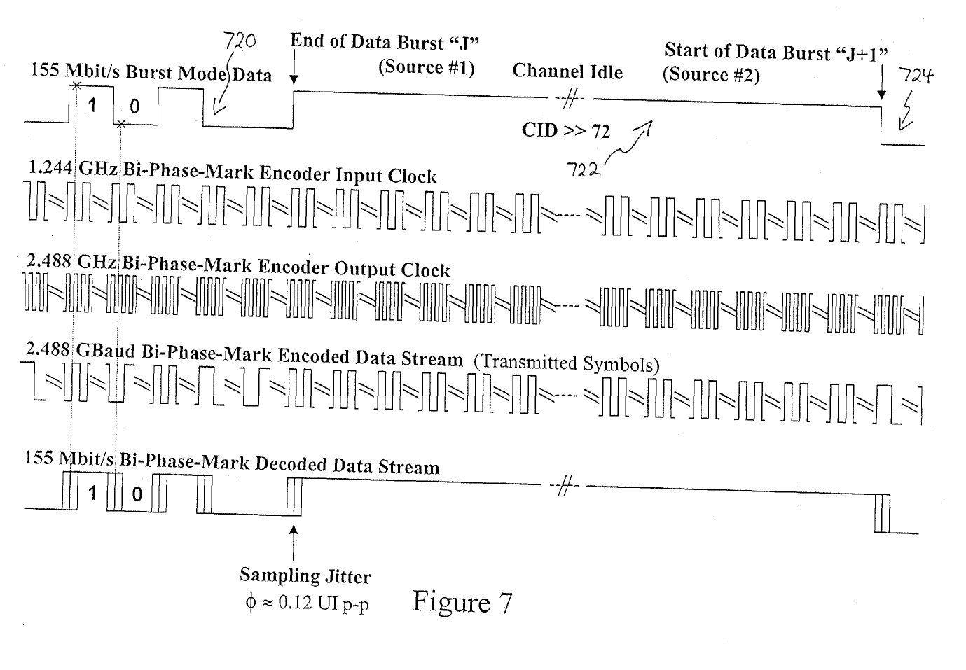

The asynchronous, oversampled bi-phase application of the invention enables the transmission of burst-mode packet protocols through a multi-channel, multi-node, 3R regenerative OEO WDM network. As an example, FIG. 6 illustrates a Passive Optical Network (PON) application where the WDM network 700 is used as a backhaul network for several PON service areas 702, 704, 706. The WDM network 700 may broadcast synchronous downstream traffic at 2.488 Gbit/s to all client PON interfaces 708, 710, 712 using a single wavelength λ₄ and may collect the burst-mode 155 Mbit/s upstream traffic from each PON 702, 704, 706—transmitting this traffic to the Central Office 714 (or Head End) via wavelengths λ₁, λ₂ and λ₃ for example (one per PON). FIG. 6 shows two data sources 716, 718 and FIG. 7 shows data burst “J” 720 arriving from Source 716 followed by a lengthy idle period 722, then data burst “J+1” 724 arriving from Source 718 (FIG. 6). By using oversampled bi-phase-mark encoding, the lengthy idle period 722 is transported most efficiently by the WDM network 700 (FIG. 6) through many AC-coupled regenerative OEO nodes. Note that 2.488 Gbit/s bi-phase encoding of the 155 Mbit/s upstream data bursts 720, 724 results in a maximum one-off sampling jitter of 0.12 UI p-p, which is acceptable.

The following examples further illustrate the breakpoint between the synchronous and asynchronous modes of bi-phase operation. The following assumptions apply:

1) A regenerative WDM network is designed to support a maximum data rate of 2.488 Gbit/s—which supports native SONET-OC48 and SDH-STM16 protocols.

2) The WDM network is AC-coupled from the bi-phase encoder output of the ingress interface to the bi-phase encoder input to the egress interface (called the bi-phase coded data or AC-coupled regenerative domain).

3) The low frequency filter roll-off defined by HPF-f_{-3 dB} is low enough to support the jitter and wander requirements of OC48 and STM-16. These protocols would generally bypass the bi-phase encoder and decoder on the client interfaces so that the WDM optical receiver bandwidth is optimised for minimum bandwidth and noise and maximum transmission distance.

4) Outside the AC-coupled, bi-phase coded data domain, the client interface may DC-couple the native data stream to support asynchronous and burst-mode applications.

5) The maximum acceptable asynchronous sampling jitter is 0.15 UI pk-pk.

Assumption 5) is representative of what is acceptable. It limits the maximum asynchronous data rate to 186.6 Mbit/s when utilising an oversampled bi-phase encoder input clock rate of 1.244 GHz and a bi-phase encoder output clock rate of 2.488 GHz. The 1.244 GHz clock is asynchronous with respect to the input data stream, which results in an effective jitter of 0.15 UI pk-pk at a data rate of 186.6 Mbit/s. For all other data rates >186.6 Mbit/s, synchronous bi-phase, oversampled synchronous bi-phase, or native signal transmission are preferably required.

At a lower data rate, such as 155.52 Mbit/s (OC3/STM1), the same bi-phase encoder input and output clock rates (1.244 GHz, 2.488 GHz) would result in an effective jitter of 0.12 UI pk-pk (if asynchronously oversampled) which is acceptable.

At the 100BaseFX (native 4B/5B encoded Fast Ethernet) rate of 125 Mbit/s, the same bi-phase encoder input and output clock rates would result in an effective jitter of 0.10 UI pk-pk (if asynchronously oversampled) which is good.

At the OC1 rate of 51.84 Mbit/s, the same bi-phase encoder input and output clock rate would result in an effective jitter of 0.04 UI pk-pk (if asynchronously oversampled) which is very good.

For a first-order high pass filter, it can be shown that for 0.10 UI pattern dependent jitter per AC-coupled transmission stage, the value of HPF-f_{-3 dB} required to AC-couple the above-mentioned 2.488 Gbaud bi-phase encoded stream through a regenerative WDM network will be approximately 100 MHz. This is 40 times greater than the value of HPF-f_{-3 dB} required to AC-couple the native 2.488 Gbit/s OC48/STM16 stream for the same jitter and a CID=72 (being approx. 2.5 MHz).

For data rates greater than 186.6 Mbit/s, the sampling jitter introduced is greater than 0.15 UI and for the purpose of this example, is deemed inadequate. For the higher data rates, it is therefore necessary to employ synchronous bi-phase encoding options (standard or oversampled), as mentioned above.

For 200 Mbit/s ESCON for example, this may be bi-phase encoded at the 400 Mbaud line rate, assuming that the multi-rate CDRs throughout the regenerative WDM network support this rate. CDR support is likely at this rate. If this is not the case, then an oversampled bi-phase option could be 2.400 Gbaud (effective N=12), which may be sufficiently close to 2.488 Gbaud for the multi-rate CDRs to acquire lock (with an appropriate loop bandwidth setting programmed into the CDR during connection establishment).

With a value of HPF-f_{-3 dB}=100 MHz, AC-coupling the above-mentioned 400 Mbaud bi-phase encoded stream through a regenerative OEO WDM network results in approximately 0.04 UI of jitter per AC-coupled transmission stage. Several such 2R regeneration stages could concatenated, however, the pattern dependent jitter will accumulate linearly with the number of stages, so a 3R regenerator stage would be required after approx. every four AC-coupled 2R regenerator stages.

So far, the focus has been on scenarios where a less constrained transmission protocol such as OC48 is the highest data rate to be supported—thus placing upper and lower limits on the WDM transmission system bandpass filter rolloff frequencies (HPF-f_{-3 dB} and LPF-f_{-3 dB}). Such unconstrained protocols make the AC-coupling filter designs more complex and severely limit the low frequency capacity and relative signal amplitude that can be allocated to a subcarrier FDM multiplexed Embedded Operations Channel (EOC).

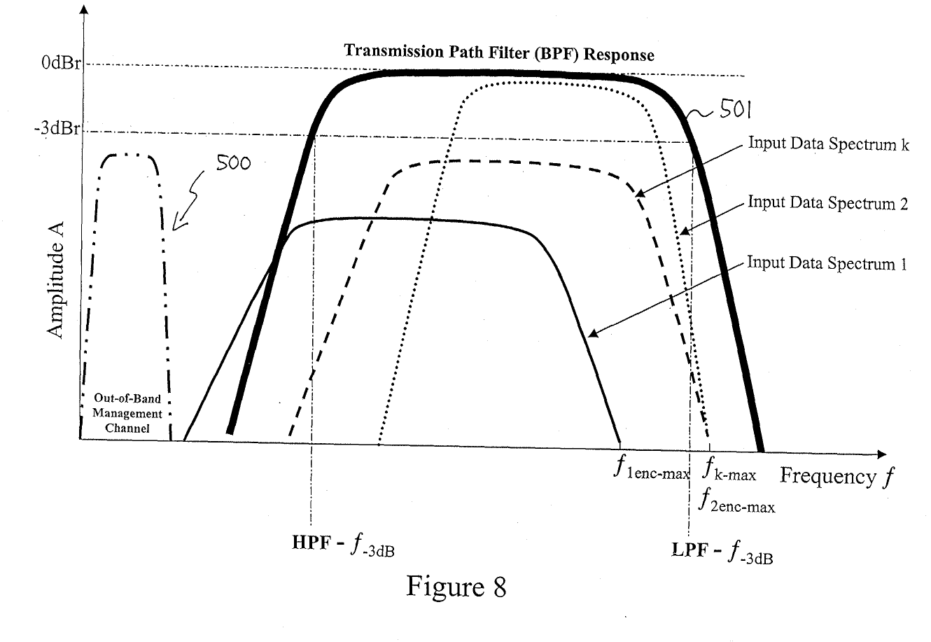

The above problem is reduced if the highest rate client protocol were more constrained, with zero DC spectral content. If this was 2 Gbit/s Fibre Channel for example, which is 8B/10B encoded, then for less than 0.10 UI pattern dependent jitter per AC-coupled 2R regeneration stage, it is possible that an HPF-f_{-3 dB} value of 25 MHz could be used for all standard client optical interface protocols. This would simplify the AC-coupling filter design and would substantially increase the low frequency bandwidth available for an out-of-band EOC channel. Within the 1R regeneration segments of each WDM link, it is feasible to sub-carrier multiplex a native 20 Mbaud, Manchester encoded Ethernet channel within the 25 MHz bandwidth. This is possible without significantly reducing the performance of the bi-phase encoded client protocols or the native 8B/10B encoded Gigabit Ethernet (1.25 Gbit/s), 1 Gbit/s and 2 Gbit/s Fibre Channel protocols. Such an out-of-band Ethernet management channel could in some applications be made available on just one wavelength or on each and every wavelength in the system. This is illustrated in FIG. 8, in which input data spectra k, 1, and 2 have been rate multiplied in accordance with an embodiment of the present invention and chosen such that they all fall within the Transmission Path Filter (BPF) Response 501. A, out-of-band portion 500 is thus available for an out-of-band management channel.

Fractional Rate Multiplier Encoding Options

If a regenerative OEO WDM network deploys continuous-rate CDRs throughout, and there is no component multi-sourcing limitation in doing so, then the option is available to apply a rate multiplying encoder which is more spectrally efficient.

Fractional rate multiplying encoders that meet the minimum requirements outlined above include for example: 4B/5B; 5B/6B; and 8B/10B block encoders.

Advantages of the 8B/10B encoder include:

Highly constrained CID (≦5);

The possibility of applying a single type of 8B/10B performance monitor throughout the regenerative OEO WDM network—for both the native protocols which are already 8B/10B encoded, and for the other protocols for which the extra layer of 8B/10B encoding is added by the client interface card or module.

If OC48 is the highest native data rate, then this could be encoded to a 3.110 Gbaud line rate. This is close the 3.125 Gbaud rate supported by several continuous-rate and multi-rate CDRs and cross-connect switches. The 3.125 Gbaud rate is used as a parallel interface for the 10 Gigabit Ethernet standard and as a means of transporting multiple OC48 streams over long backplanes.

In asynchronous applications where low data rate and highly unconstrained (eg, burst-mode) data streams must be transported, then oversampling of the native data stream at a much higher rate and then encoding this at the 10/8 rate, can be used to transport the unconstrained data long distances over a regenerative 3R network. In such applications, the benefit of the 10/8 fractional rate encoder is that a higher sampling rate can be used for the same maximum WDM channel rate (fₘₐₓ). For example, if the maximum WDM channel rate is 3.125 Gbit/s, then a maximum sampling rate of 2.5 GHz can be applied to the low data rate and unconstrained data streams. For a maximum of 0.15 UI pk-pk sampling jitter, the maximum asynchronous data rate is 375 Mbit/s.

If all data streams are pre-encoded (as a native protocol) or post-encoded (by the client interface) with a N=10/8 fractional rate encoder (such as 8B/10B), then a single type of client interface card/module and encoder can be implemented for all protocols and data rates up to the maximum WDM channel rate divided by N.

It is possible to significantly increase the bandwidth available to an out-of-band EOC channel due to the reduction in low frequency content in the encoded signal.

Whilst 8B/10B is the preferred embodiment of the fractional rate multiplying encoder options, other encoder options which result in a 10/8 rate multiplier are also possible. For example, a 5B/6B encoder could be used to constrain the native data stream, with 8 encoded data blocks inserted into a 50-bit frame structure which is then clocked at the 10/8 rate. The extra 2 bits per frame could be used for a DC-balanced frame sync pattern and in-band management channel.

The in-band management channel rate would be 1/50^{th} of the encoded data rate. If the minimum encoded data rate is 100 Mbit/s for example, then the in-band management channel rate would be 2 Mbit/s. If this was Manchester encoded to maintain the DC-balance, then the management data rate would be 1 Mbit/s.

Other benefits of such an embodiment are:

Both the 5B/6B encoder stage and the frame sync pattern provide two sources of BER performance monitoring;

Greater reduction in low frequency content and associated support for a higher bandwidth out-of-band EOC channel.

In the following, another group of embodiments will be described, which utilise dual encoder/decoder systems.

The previous example demonstrated the advantages of constraining the data pattern and associated frequency spectra of all protocols in a regenerative OEO WDM network. This proved to be easy for higher rate client protocols that are already suitable encoded (eg, Gigabit Ethernet, Fibre Channel, 2 Gbit/s Fibre Channel), or for low-medium rate protocols that can be bi-phase encoded. The roadblock appears to be the OC48/STM16 protocol. However, such a roadblock only exists because it tried to limit the maximum WDM channel bandwidth to reduce the optical receiver noise and maximise the link distance. In practice, the reduction in receiver sensitivity and link transmission distance is not large if a spectrally efficient line code is used to encode the OC48/STM16 stream.

Many electronic devices designed for WDM networks are specified to operate at transmission rates up to 3.125 Gbit/s. Examples include multi-rate and continuous-rate CDRs, cross connect switches and a new generation of Field programmable Gate Arrays (FPGAs) with multi-rate or continuous-rate CDRs and Serialiser/Deserialiser (SERDES) front ends. This has been done to support previous digital wrapper protocols with FEC, high-speed parallel backplanes and to support the new WWDM (Wide WDM) variant of the 10 Gigabit Ethernet standard.

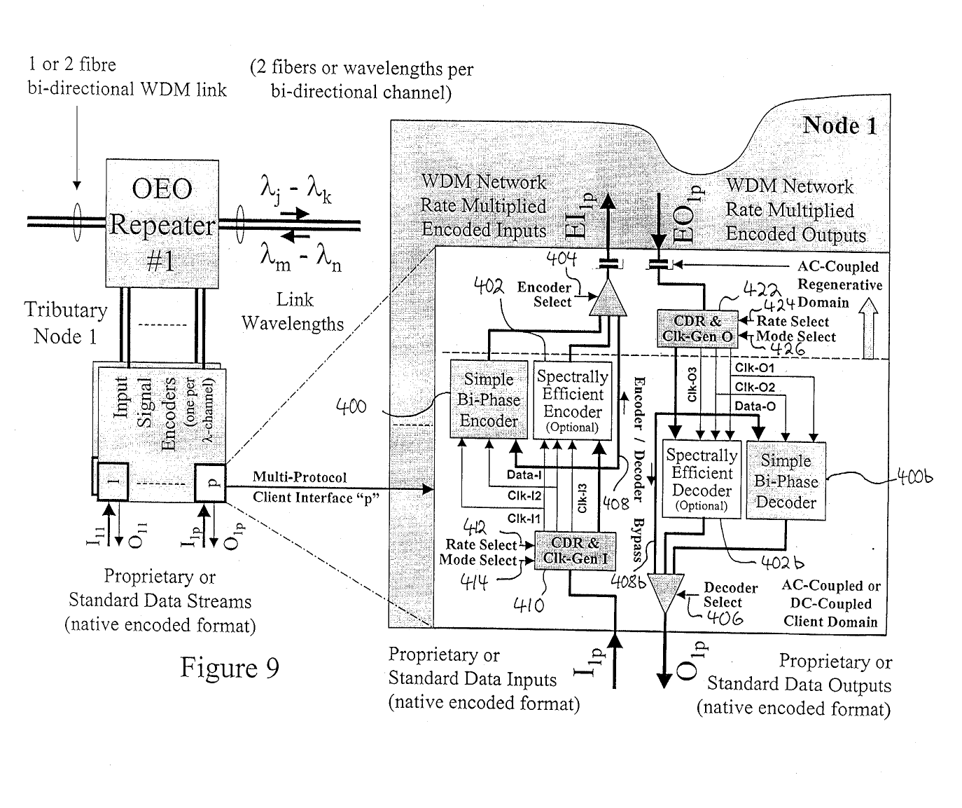

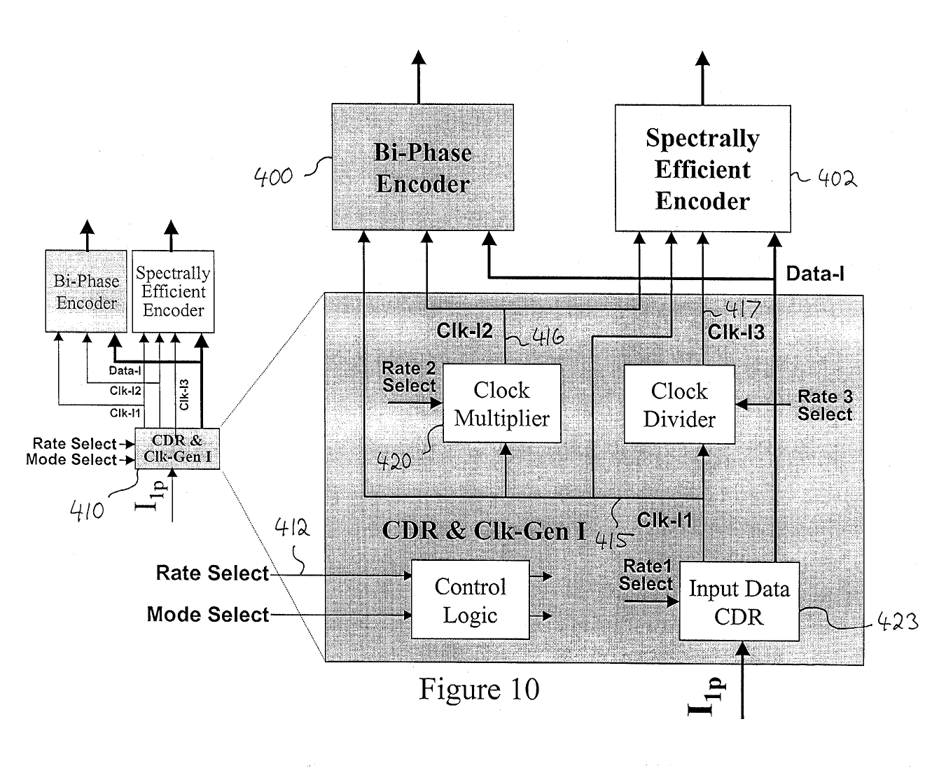

Another embodiment which includes two encoder types, is shown in FIGS. 9 and 10.

In FIG. 9, one encoder is a simple rate multiplying encoder, in the example embodiment a bi-phase encoder 400. This encoder 400 would be selected for all client protocols (except OC48/STM16 for example) that are unsuitable for transmission through the OEO WDM network in their native format. The encoder 400 permits multi-rate CDRs to be used throughout the OEO WDM network.

The less constrained, higher rate protocols such as OC48/STM16 that cannot be bi-phase encoded, would be encoded with a different, spectrally efficient line code that removes the DC spectral component and a substantial amount of low frequency content. This is discussed in more detail below. Other native protocols that are suitably constrained and are of a high enough data rate, would not be encoded, but rather would bypass the two encoders 400, 402.

In the example embodiment a 10/8 fractional rate multiplying encoder 402 is used, which for the 2.488 Mbit/s native rate results in an encoded rate of 3.110 Gbaud. This is sufficiently close to 3.125 Gbaud that the multi-rate CDRs specified to support this clock rate should have little trouble locking onto the 3.110 Gbaud rate, assuming that their loop filter bandwidth is programmed appropriately at connection set-up.

Whilst some multi-rate CDRs will support the 10/8 multiple of 2.488 Mbit/s, this does not mean that they will support the 10/8 multiple of all standard protocols and rates. This is why the bi-phase encoder 400 is available as well in the example embodiment.

As shown in FIG. 9, Encoder and Decoder Select control inputs 404, 406 are used to select one of the two Encoder/Decoder options 400, 400b, 402, 402b, or the bypass option 408, 408b.

Associated with the Encoder 400, 402 inputs is a multi-rate CDR and Clock Generator (Clk-Gen) 410. This can be programmed via the Rate Select and Mode Select control inputs 412, 414. The programmed state may e.g. be to support standard effective (2×) or 2^{M}×native rates for the synchronous encoding or bypass modes, or it can be programmed to the highest supported WDM channel rate for example, to support the asynchronous encoding modes. In the latter case, the client side of the encoder and decoder is preferably DC-coupled.

As shown in FIG. 10, the Rate Select input 412 generates multiple clock signals 415, 416, 417, such as the 1× and 2× clocks required for bi-phase encoding 400 of the client data stream, or a 0.125× and 1.25× clocks for example for the 10/8 encoding option 402. The CDR and Clk-Gen functional block 410 may also retime the client data stream to reduce input jitter for the synchronous encoding and bypass modes of operation.

Note that the clock multiplier block 420 shown in FIG. 10 may be implemented with a multi-rate CDR. In this case, its data input is the clock output of the CDR 423 used to retime the input data stream I₁ₚ. When used as a frequency doubler for example, the data input to the clock multiplier CDR would look like a repetitive 11001100 . . . pattern which it should easily synchronise to. More generally, the clock multiplier 420 is programmed via Rate Select 2 to the desired encoder output clock rate. This technique should in principal work for 2≦N≦72, although a smaller value of N may be required for to acquire lock, if implemented using a CDR.

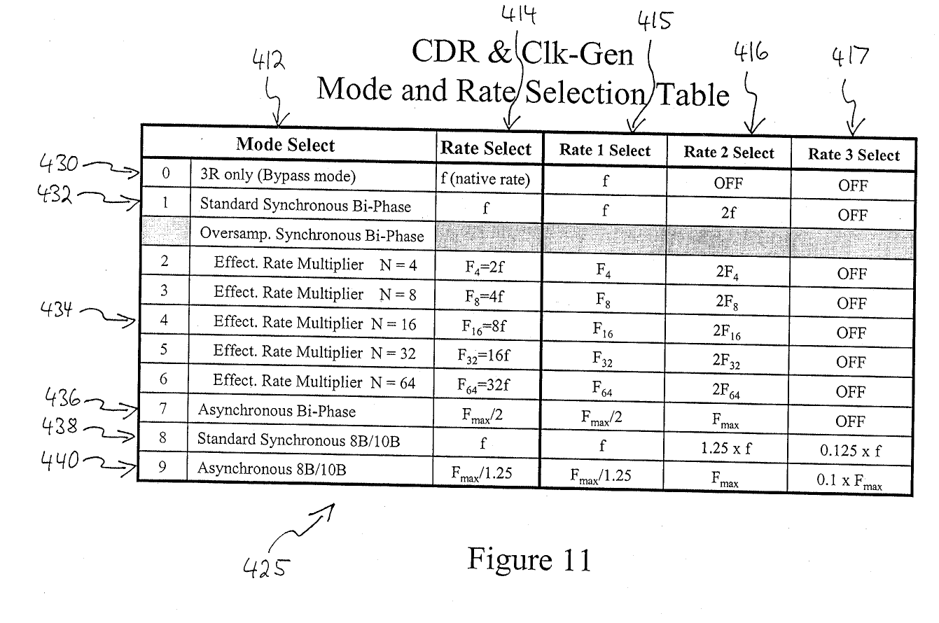

FIG. 11 shows a table 425 summarising rate select and mode select control input options 412, 414, as well as the multiple clock signals 415, 416, and 417 for the example embodiment illustrated in FIGS. 9 and 10.

For example, in a 3R only or bypass mode (row 430), the rate select 414 and corresponding rate 1 select 415 are set to the native data rate, while the rate 2 select 416 and the rate 3 select 417 are turned off, as they are not in use in this mode. Thus, the native data stream is not encoded, but only retimed at input data CDR 422 (FIG. 10).

In the standard synchronous bi-phase mode (row 432), the rate select 414 as well as the corresponding rate 1 select 415 are set to the native rate. Rate 2 select 416 is set to 2× the native rate to achieve the rate doubling of the bi-phase encoding. Rate 3 select 417 is turned off/not in use.

In an oversampled synchronous bi-phase mode, e.g. with an effective rate multiplier N=16 (row 434) the rate select 414 and corresponding rate 1 select 415 are set to 8× the native data rate. The rate 2 select 416 is set to 2× (8× the native data rate) for the bi-phase encoding of the oversampled data stream. Again, rate 3 select 417 is off/not in use.

In the asynchronous bi-phase mode (row 436), rate select 414 and corresponding rate 1 select 415 are set to half the maximum data rate Fₘₐₓ in the WDM network. The rate 2 select 416 is set to Fₘₐₓ, for effecting the bi-phase encoding of the oversampled data stream. Again, rate 3 select 417 is off/not in use.

In the standard synchronous 8B/10B mode (row 438), rate select 414 and corresponding rate 1 select 415 are set to the native data rate. Rate 2 select 416 and rate 3 select 417 are set to 1.25× the native data rate and 0.125× the native data rate respectively, for effecting the 8B/10B encoding.

Finally, in the asynchronous 8B/10B mode (row 440), the rate select 414 and corresponding rate 1 select 415 are set to Fₘₐₓ divided by 1.25. Rate 2 select 416 and rate 3 select 417 are set to Fₘₐₓ and 0.1× Fₘₐₓ respectively, for effecting the 8B/10B encoding of the oversampled data stream.

Returning now to FIG. 9, associated with the Decoder select inputs 406 will be a multi-rate CDR and Clock Generator 422 with associated Rate Select and Mode Select control inputs 424, 426. These have similar functions as described for the Encoder inputs 412, 414 above with reference to FIG. 9, 10 and 11.

Whilst FIGS. 9, 10 and 11 show a “universal” client interface embodiment that supports all protocols and data rates up to the maximum WDM channel rate Fₘₐₓ, another embodiment would be to have two types of client interfaces—one for each encoder type. Another possibility is a 3^{rd} client interface type, which performs no additional encoding of the native data stream, i.e. the Bypass mode.

The benefit of implementing the dual-encoder design on more than one type of client interface is that each client interface is not compromised in terms of design complexity and cost, by an Encoder block that at any one time is not being used.

However, this approach requires an additional order-part which has a logistics support cost. This is exacerbated if there is a client interface card/module variant for each wavelength to be transported by that node.

The following is a summary of the 3-interface design option embodying the present invention:

The Type 1 (3R) client interface would bi-phase encode all protocols and data rates except those protocols and rates that require the spectrally efficient encoder.

The Type 2 (3R) client interface would encode all high-speed protocols and rates that require the spectrally efficient 10/8 encoder.

The Type 3 (2R/3R) client interface would pass all protocols and rates which are already suitably encoded for transmission through a regenerative WDM network.

It will be appreciated by the person skilled in the art that numerous modifications and/or variations may be made to the present invention as shown in the specific embodiments without departing from the spirit or scope of the invention as broadly described. The present embodiments are, therefore, to be considered in all respects to be illustrative and not restrictive.

In the claims that follow and in the summary of the invention, except where the context requires otherwise due to express language or necessary implication the word “comprising” is used in the sense of “including”, i.e. the features specified may be associated with further features in various embodiments of the invention.

1. An electro-optic interface structure for use in a multi-protocol OEO WDM network, the interface structure comprising:
a rate multiplying encoding unit for applying a rate multiplying line code to an electrical transmit data signal prior to conversion of the electrical transmit data signal into an optical WDM channel signal, and
a rate dividing decoding unit for applying a corresponding rate dividing line code to an electrical receive data signal converted from a received optical WDM channel signal,
wherein the encoding unit is arranged such that, in use, the same rate multiplying line code can be applied to electrical transmit data signals of different protocols, and
wherein the decoding unit is arranged such that, in use, the application of the same corresponding rate dividing line code can create electrical signals of different protocols.

2. An interface structure as claimed in claim 1, wherein the encoding unit comprises a plurality of encoding elements and the decoding unit comprises a plurality of decoding elements, wherein different pairs of encoding and decoding elements apply, in use, different line codes, and the encoding unit further comprises an encoder select element for selecting one of the encoding elements, and a decoding select element for selecting one of the decoding elements.

3. An interface structure as claimed in claim 1, wherein the interface structure further comprises an encoding by-pass element for by-passing one or more associated encoding elements for an electrical transmit data signal having a suitable format and a rate above a threshold value, and a decoding by-pass element for by-passing one or more decoding elements for an electrical receive data signal corresponding to an electrical transmit data signal having a suitable format and a rate above the threshold value.

4. An interface structure as claimed in claim 3, wherein the encoder select element and the decoder select element comprise the encoding by-pass element and the decoding by-pass element respectively.

5. An interface structure as claimed in claim 1, wherein the interface structure comprises at least one encoding sampling element arranged, in use, to oversample the electrical transmit data signal prior to the application of the rate multiplying line code, whereby a total rate multiplying factor greater than a factor inherent to said applied rate multiplying line code is achieved, and the interface structure further comprises at least one decoding sampling element arranged, in use, to de-sample the decoded electrical receive data signal.

6. An interface structure as claimed in claims 1 or 6, wherein the encoding unit is arranged, in use, such that the encoded electrical transmit data signal is synchronised with respect to the original electrical transmit data signal.

7. An interface structure as claimed in claims 1 or 6, wherein the encoding unit is arranged, in use, such that the encoded electrical transmit data signal is asynchronous with respect to the original electrical transmit data signal, wherein a or the total rate multiplying factor for said original electrical transmit data signal is chosen sufficiently high such that a sampling jitter in the encoded electrical transmit data signal is below a predetermined threshold value.

8. An interface structure as claimed in claim 1, wherein the encoding unit comprises a first clock data recovery (CDR) element arranged, in use, to be set selectively to the rate of the electrical transmit data signal for retiming the electrical transmit data signal.

9. An interface structure as claimed in claim 8, wherein the encoding unit further comprises a first clock multiplier element arranged, in use, to create a multiplied clock output signal based on a clock output signal of the first CDR element for use in one of the encoding elements.

10. An interface structure as claimed in claim 9, wherein the encoding unit further comprises a first clock divider element arranged, in use, to create a divided clock output signal based on the clock output signal of the first CDR element for use in said one of the encoding elements.

11. An interface structure as claimed in claim 9, wherein the first clock multiplier element comprises a second CDR element.

12. An interface structure as claimed in claim 1, wherein the decoding structure comprises a third CDR element arranged, in use, to be set selectively to the rate of the electrical receive data signal for retiming the electrical receive data signal.

13. An interface structure as claimed in claim 12, wherein the decoding unit further comprises a second clock divider element arranged, in use, to create a divided clock output signal based on the clock output signal of the third CDR element in for use in one of the decoding elements.

14. An interface structure as claimed in claim 13, wherein the decoding unit further comprises a second clock multiplier element arranged, in use, to create a multiplied clock output signal based on a clock output signal of the third CDR element for use in said one of the decoding elements.

15. An interface structure as claimed in claim 14, wherein the second clock multiplier element comprises a fourth CDR element.

16. An interface structure as claimed in claims 11 or 15, wherein the CDR elements comprise multi-rate CDR elements, wherein the rate multiplying codes are chosen such that, in use, the multi-rate CDR elements are capable of locking to the range of multiplied rates.

17. An interface structure as claimed in claims 11 or 15, wherein the CDR elements comprise continuous rate CDR elements, whereby the CDR elements are capable of locking to substantially any multiplied rate, including fractionally multiplied rates.

18. An interface structure as claimed in claim 1, wherein the interface structure further comprises an in-band management unit arranged, in use, to utilise a portion of the multiplied rate spectrum transmitted in the OEO WDM network, due to the application of the rate multiplying line code, for an in-band management application.

19. An interface structure as claimed in claim 18, wherein the in-band management application may comprise forward error control (FEC), bit-error rate estimation, signal path tracing or an end-end management application.

20. An interface structure as claimed in claim 1, wherein the interface structure is formed on a single interface card, or in the form of an individual transmit interface card comprising the encoding unit, and an individual receive interface card comprising the decoding unit.

21. An interface structure as claimed in claim 1, wherein the encoding unit is formed on a single card, or in the form of individual cards each comprising one or more of the encoding elements.

22. An interface structure as claimed in claim 1, wherein the decoding unit is formed on a single card, or in the form of individual cards each comprising one or more of the decoding elements.

23. An interface structure as claimed in claim 1, wherein the encoding unit comprises at least one encoding element arrangement, in use, to apply a bi-phase multiplying line code, and the decoding unit comprises at least one decoding element arranged, in use, to apply a bi-phase dividing line code.

24. An interface structure as claimed in claim 23, wherein the interface structure comprises at least one encoding sampling element arranged, in use, to oversample the electrical transmit data signal prior to the application of the bi-phase line code, whereby a total rate multiplying factor greater than 2 is achieved, and the interface structure further comprises at least one decoding sampling element arranged, in use, to de-sample the decoded electrical receive data signal.

25. An interface structure as claimed in claim 24, wherein the encoding unit is arranged, in use, such that the encoded electrical transmit data signal is synchronised with respect to the original electrical transmit data signal.

26. An interface structure as claimed in claim 24, wherein the encoding unit is arranged, in use, such that the encoded electrical transmit data signal is asynchronous with respect to the original electrical transmit data signal, wherein the total rate multiplying factor for said original electrical transmit data signal is chosen sufficiently high such that a sampling jitter in the encoded electrical transmit data signal is below a predetermined threshold value.

27. A method of transmitting a user electrical transmit data signal through a multi-protocol OEO WDM network, the method comprising the steps of:
applying, at a source network node, a rate multiplying line code to the electrical transmit data signal prior to conversion of the electrical data signal into an optical WDM channel signal, and
applying, at a destination network node, a rate dividing line code to an electrical receive data signal converted from the optical WDM channel signal,
wherein the same rate multiplying line code is applied to electrical signals of different protocols at the source network node, and
wherein the application of the same rate dividing line code can create electrical signals of different protocols at the destination network node.

28. A multi-protocol OEO WDM network comprising an electro-optic interface as claimed in claim 1.
